(19) United States
(12) Patent Application Publication
(10) Pub. No.: US 2004/0111433 A1
(43) Pub. Date: Jun. 10, 2004

(54) System and method for medical data analysis

(76) Inventors: Kumiko Seto, Fuchu (JP); Takahiko Shintani, Tokyo (JP); Satoshi Mitsuyama, Tokyo (JP); Hideyuki Ban, Hachioji (JP); Takeshi Hasiguchi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/361,628

(22) Filed: Feb. 11, 2003

(30) Foreign Application Priority Data
Dec. 6, 2002 (JP) 2002-354873

(51) Int. Cl. G06F 17/60; G06F 7/00; G06F 17/00

(52) U.S. Cl. 707/104.1; 705/2

(57) ABSTRACT

The present invention aims to provide a medical data analytic system which can efficiently generate relationships between data forming the evidence from large volumes of medical data, and support a doctor's diagnosis. The system includes a calculating device comprising a medical data analysis unit, a database comprising a medical data storage unit, and an input/output device comprising a condition input unit for inputting n diagnosis-related conditions. Depending on the aforesaid n conditions, the ratio of 2ₙ groups of medical data for analysis corresponding to all combinations of conditions is calculated for the case when the conditions are satisfied and the case when they are not satisfied, and displayed on an output unit of the input/output device.

### BACKGROUND OF THE INVENTION

The present invention relates to a medical data analytic system for supporting a doctor's diagnosis using diagnostic data.

In recent years, the practice of Evidence-Based Medicine (EBM) is an important concept in providing high quality insurance medical care. At the same time, due to the higher level of network integration and the generalization of electronic patient records for electronically managing diagnostic data, huge medical databases are now being constructed. As a result of these trends, it is now possible to dynamically obtain evidence from databases, so that in the future it will be possible for medical institutions to generate the evidence and evaluate the generated evidence in order to provide high-quality services implementing EBM. Additionally, to implement EBM, it is important to be able to generate the evidence efficiently from an analysis of medical data.

An embodiment of an existing data analysis technique is Online Analytical Processing (OLAP) (e.g., Muranaga et al 3: “Construction of hospital data warehouse using data accumulated by a hospital information system”, Journal of the Japan ME Academy (2002), pp. 8-17)

OLAP provides various queries for analyzing large volumes of multi-dimensional data, and data manipulation functions. A doctor can make use of these functions to perform an analysis when he gives an opinion in providing medical care. For example, the OLAP which are already commercially available provide tools for (1) analysis items and summation, (2) data generation based on (1), and (3) looking up data.

When OLAP analyzes data, (1) and (2) are first performed by an operator conversant with the database, and in (3), a doctor at a medical care facility then looks up summarized results while going through analysis items designed in (1).

The problems involved when the doctor analyzes data at a medical care facility to make a diagnosis are, (1) improving processing speed, (2) simplifying operation and (3) displaying analysis results in an easily understandable form so that a decision can be rapidly made.

Of these, in the aforesaid prior art technology, concerning (1), as the data is already summed, the doctor can perform a rapid search when he carries out an analysis. Also for (2), operations can be performed visually, so the summed results can be recalculated by simply replacing analysis items with drag and drop. However, in the aforesaid prior art technology, since it is necessary to clearly display analysis items, when the object of the analysis is unknown, the analysis items and summaries must be repeatedly redesigned while referring to total results on each occasion. Therefore, this is not suitable for application to data when the object is unclear.

Also, for (3), when referring to summed results, summed values are displayed for combinations of all values for each item. However, depending on the combinations of items, there will be an enormous number of results and a large number of unnecessary combinations, so the efficiency of the analysis falls.

### SUMMARY OF THE INVENTION

It is therefore an object of the present invention to provide a medical data analytic system which can efficiently generate relationships between data forming evidence from a large volume of medical data, and thereby support a doctor's diagnosis.

To achieve the above object, the medical data analytic system according to the present invention comprises a database having a medical data storage unit which stores medical data for analysis, an input unit for inputting n search conditions (where n is a positive integer, and n≧2) relevant to diagnosis, a calculating device comprising a medical data analysis unit which generates 2ⁿ groups corresponding to all of the combinations when each n search condition is satisfied and when it is not satisfied from medical data for analysis in the medical data storage unit, and calculates a ratio of the generated data to all medical data for analysis relevant to the n search conditions, and an input/output device comprising an output unit which outputs the ratio obtained by the calculating device, and the search condition input unit.

In the medical data analytic system according to the present invention, the calculating device comprises a data mining unit which generates association rules showing data correlations and a support count from the medical data for analysis, the input/output device comprises an association rule selection unit for selecting desired association rules from the association rules, and the medical data analysis unit calculates and outputs the aforesaid ratio according to the association rules selected by the association rule selection unit.

In the medical data analytic system according to the present invention, the database comprises a data mining result storage unit which stores the association rules and the support count generated by the data mining unit, and the medical data analysis unit calculates the aforesaid ratio from the support count stored by the data mining result storage unit.

In the medical data analytic system according to the present invention, the medical data storage unit comprises diagnostic information including laboratory results for diagnosis and a standard value table which stores upper values and lower values showing permitted ranges for the diagnostic information having continuous values, and sets the upper values and lower values as search conditions for the diagnostic information in the search condition input unit.

In the medical data analytic system according to the present invention, the input/output device displays the ratio obtained by the calculating device.

The medical data analysis method according to the present invention comprises a step for inputting diagnostic preconditions, a step for inputting n search conditions (where n is a positive integer, and n≧2) relevant to diagnosis into input/output means, and a step for generating 2ⁿ groups corresponding to all of the combinations when each n search condition is satisfied and when it is not satisfied from medical data for analysis prestored in a memory means, and calculating and outputting a ratio of the generated data relative to data satisfying the preconditions.

The medical data analysis method according to the present invention includes a step for selecting the combinations, and setting new preconditions based on conditions relevant to the selected combinations.

The medical data analysis method according to the present invention comprises a step for displaying the aforesaid ratio.

The medical data analysis method according to the present invention, wherein desired medical data is input, and medical data in medical data for analysis having the highest correlation to the desired medical data is displayed, comprises a step for calculating association rules showing data correlations and a support count from the medical data for analysis, a step for retrieving the association rules having input medical data items in a conclusion, a step for calculating the support count relative to combinations of conclusions from the retrieved association rules, and a step for displaying assumptions related to combinations of conclusions having the highest support count from the support counts related to combinations of conclusions matching the medical data.

### BRIEF DESCRIPTION OF THE DRAWINGS

FIG. 1 is a diagram describing the construction of a medical data analytic system according to a first embodiment of the present invention.

FIG. 2 is a flowchart describing the procedure according to the first embodiment of the present invention.

FIG. 3 is a diagram showing a typical screen display of an input/output device according to the first embodiment of the present invention.

FIG. 4 is a diagram describing a typical construction according to the second embodiment and third embodiment of the present invention.

FIG. 5 is a diagram showing a procedure and typical screen display of an input/output device according to the second embodiment of the present invention.

FIG. 6 is a flowchart showing the procedure according to the third embodiment of the present invention.

FIG. 7 is a diagram showing the procedure according to a fourth embodiment of the present invention, and describing the screen display procedure with reference to the screen display of FIG. 3.

FIG. 8 is a flowchart showing the procedure according to a fifth embodiment of the present invention.

FIG. 9 is a diagram showing a typical screen display according to a sixth embodiment of the present invention.

FIG. 10 is a flowchart showing the procedure for generating diagnostic data having the highest correlations according to the sixth embodiment of the present invention.

FIG. 11 is a diagram describing the concept of generating correlation data according to the sixth embodiment of the present invention.

### DETAILED DESCRIPTION OF THE PREFERRED EMBODIMENTS

Some embodiments of the present invention will now be described referring to the drawings.

(Embodiment 1)

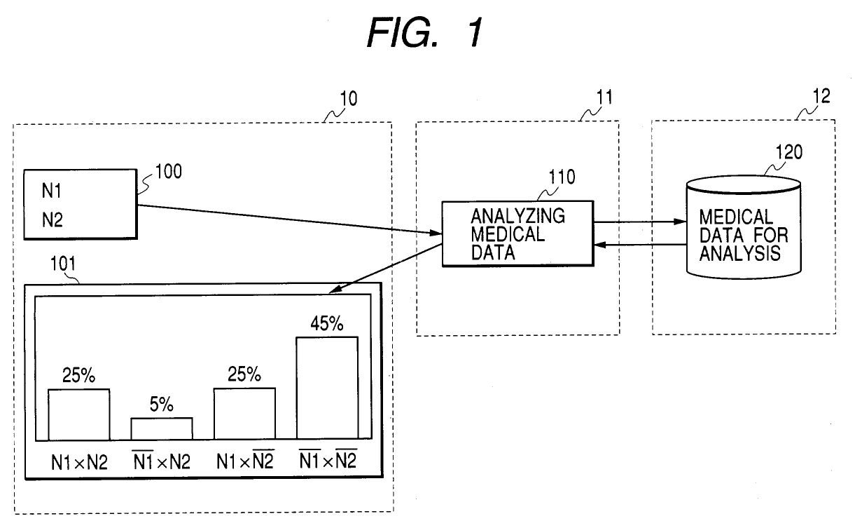

FIG. 1 is a diagram showing a typical construction of a medical data analytic system according to a first embodiment of the present invention. The medical data analytic system according to Embodiment 1 comprises an input/output device 10, a calculating device 11 and a database 12.

The input/output device 10 comprises a search condition input unit 100, and an output unit 101. The calculating device 11 comprises a medical data analysis unit 110. The medical data analysis unit 110 retrieves 2ⁿ groups of data from the data in a medical data storage unit 120 stored in the database 12 against n (where n is a positive integer, and n≧2) search conditions input from the search condition input unit 100, and performs a data analysis which calculates the ratio of this data to all the data relating to the n search conditions in each group. The results of the data analysis are displayed on the output unit 101.

Here, 2ⁿ groups of data means the data groups generated from the data in the medical data storage unit 120 for all combinations where each n search condition is satisfied and where it is not satisfied.

The medical data storage unit 120 comprises a patient information table comprising the patient's sex, age and disease, laboratory results table, prescription table and tables storing various medical data required for analysis. The tables are managed by a case ID for uniquely identifying the case, and when it is required to retrieve information connecting plural tables, the tables are connected by each case ID, and the corresponding case is retrieved. On the other hand, when it is desired to search by patient, the information may be managed by a patient ID for uniquely identifying the patient.

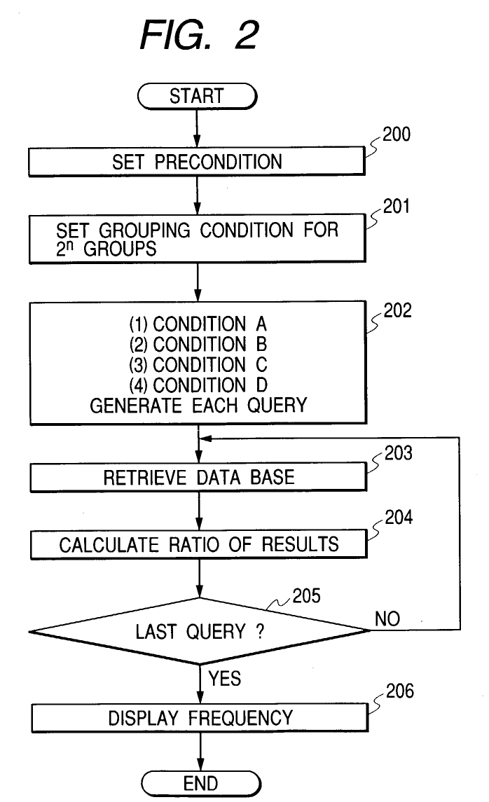

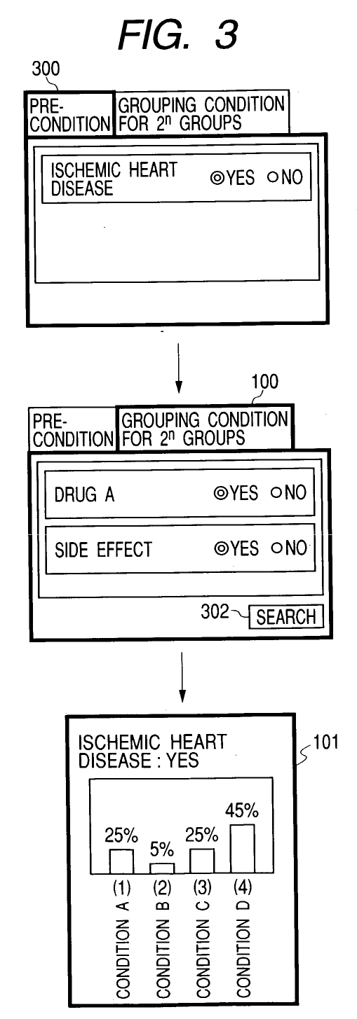

FIG. 2 shows the flow of the procedure in the medical data analysis method according to the first embodiment of the present invention, and FIG. 3 is a typical screen display of the input/output device 10 in the first embodiment. Here, an example of the medical analysis used for diagnosis will be described in the case where it is desired to administer a drug A to a patient with ischemic heart disease, and check for side effects of the drug A.

In a step 200, the doctor enters “ischemic heart disease”=“yes” as a precondition to a precondition input unit 300 in the input/output device 10. Next, in a step 201, in a search condition input unit 100, the two search conditions “drug A”=“yes”, “side effects”=“yes” are entered.

When a search button 302 is clicked, the medical data analysis unit 110 performs steps 202-206.

In the step 202, a query is generated to retrieve and generate 2² groups, i.e., 4, groups of conditions from the database, i.e., (1) ischemic heart disease”=“yes” and “drug A”=“yes” and “side effects”=“yes” (Condition A), (2) ischemic heart disease”=“yes” and not “drug A”=“yes” and “side effects”=“yes” (Condition B), (3) ischemic heart disease”=“yes” and “drug A”=“yes” and not “side effects”=“yes” (Condition C), (4) ischemic heart disease”=“yes” and not “drug A”=“yes” and not “side effects”=“yes” (Condition D).

Representing “drug A”=“yes” as N1, “side effects”=“yes” as N2, not “drug A”=“yes” as N1, not “side effects”=“yes” as N2, the statements for the above four groups of conditions may be expressed by the logic AND operations (1) N1×N2, (2) N1×N2, (3) N1×N2, (4) N1×N2 as shown in the output unit 101 of FIG. 1.

In the step 203, the medical data in the database 12 is retrieved for each of the four groups of conditions based on the statements generated in the step 202.

In the step 204, the ratio of data satisfying each group of conditions in all the data corresponding to “ischemic heart disease”=“yes” is calculated.

In a step 205, the step 203 and step 204 are repeated for the number of groups (here, four groups).

In a step 206, the ratio (frequency) of the four groups calculated in the step 204 to all the data satisfying the aforesaid preconditions is simultaneously displayed on the output unit 101. Here, assume for example that the ratios relative to the aforesaid four groups are 25%, 5%, 25%, 45% as shown in FIG. 1. As a result, it is seen that of the patients with ischemic heart disease, there are respectively 50% each of patients who received the drug A and patients who received a different drug from the drug A (shown by the case not “drug A”=“yes” ), and whereas 50% of patients who received the drug A had side effects, approximately 10 percent had side effects from drugs other than the drug A. In other words, it can be deduced that side effects were largely observed when the drug A was administered.

In usual database searches, because one search result returns as response to a query for one search condition, a search is performed for the condition (a) “drug A”=“yes” and “side effects”=“yes”, and if a result of 25% is obtained, it can be inferred that the number corresponding to a condition (b) other than (a) is 75%, but as the conditions (a), (b) cannot be compared, it cannot be deduced that there were many side effects associated with administration of the drug A as described above.

Thus, as described above, medical data relating to plural groups of conditions can be compared from one condition setting, so a precise and efficient analysis can be performed when a diagnosis is made.

(Embodiment 2)

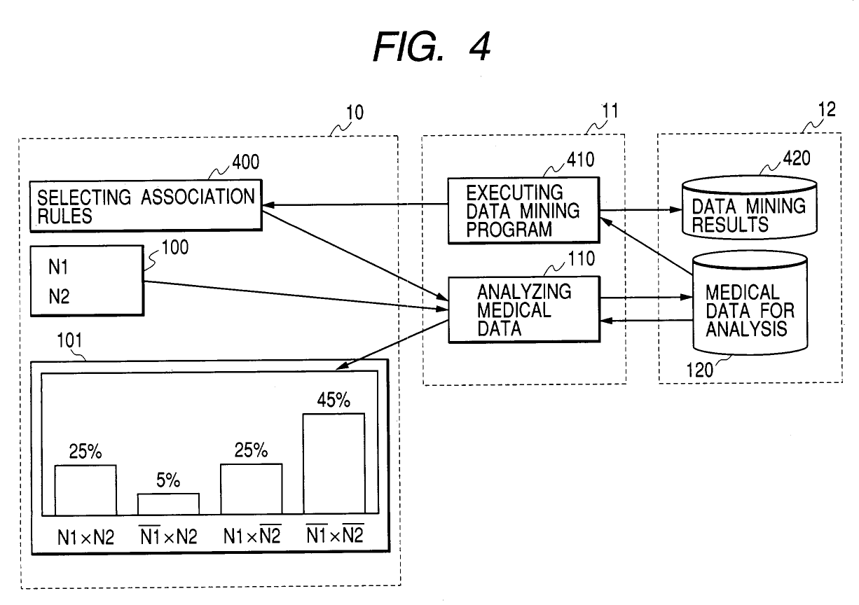

FIG. 4 shows a typical construction of a medical data analytic system according to a second embodiment and a third embodiment of the present invention to be described next. The differences of the medical data analytic system in the second and third embodiments from the construction of the medical data analytic system of the first embodiment shown in FIG. 1 will be described. The input/output device 10 shown in FIG. 4, in addition to the construction of the input/output device 10 shown in FIG. 1, further comprises an association rule selection unit 400. The calculating device 11 shown in FIG. 4, in addition to the calculating device 11 shown in FIG. 1, further comprises a data mining unit 410.

In the data mining unit 410, the data in the medical data storage unit 120 of the database 12 is comprehensively analyzed, association rules and support counts are generated, and the generation results are stored as data mining results in a data mining result storage unit 420.

The association rules are-rules showing correlations between data, and take an “if-then” form. In this embodiment, the association rules are association rules for 2ⁿ groups of data. The frequency is defined as the ratio (conditional probability) according to which, when “if” is the assumption and “then” is the conclusion, the conclusion is satisfied when the assumption is satisfied.

The data mining results are represented by the association rules (comprising assumptions and conclusions) and their frequencies.

When the user selects an association rule from the rules stored in the data mining result storage unit 420 in the association rule selection unit 400, the medical data analysis unit 110 displays a result on the output unit 101 by an identical procedure to that of the steps 202-206 of the first embodiment according to the conditions corresponding to the selected association rule.

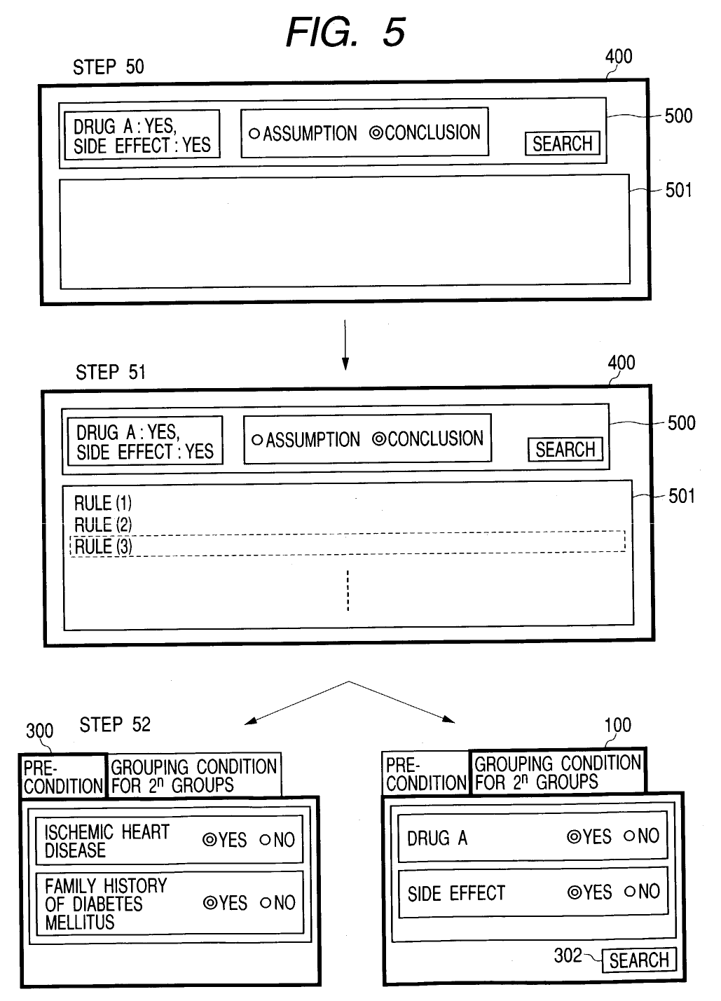

FIG. 5 is a diagram showing the procedure in the second embodiment of the present invention and a typical screen of the input/output unit 10. Here, an embodiment of which case to analyze will be described when the drug A has side effects.

The association rule selection unit 400 comprises an association rule retrieval unit 500 and an association rule display unit 501. The conditions for retrieving the rules are input from the association rule retrieval unit 500, and when “assumption” is checked or “conclusion” is checked to select it, the rule when the search condition corresponds to the assumption or to the conclusion is retrieved.

For example, in a step 50, “drug A yes”, “side effects yes” and “conclusion” are checked, and the search button is clicked. As a result, in a step 51, the rule which has “drug A”=“yes”, “side effects”=“yes” in the conclusion is selectively retrieved from the rules stored in the data mining result storage unit 420 and displayed on the association rule display unit 501. In a step 501, a rule (1) “ischemic heart disease: yes” “drug A: yes” and “side effects: yes”, a rule (2) “ischemic heart disease: yes” and “laboratory data A>1000” “drug A: yes” and “side effects: yes”, and a rule (3) “ischemic heart disease: yes” and “family history of diabetes mellitus: yes” “drug A: yes” and “side effects: yes”, are shown.

Next, association rules containing results suitable for analysis are selected from the association rules displayed on the association rule display unit 501. For example, when the patient presents with ischemic heart disease and has a family history of diabetes mellitus, it is determined that the rule “ischemic heart disease: yes” and “family history of diabetes mellitus: yes” “drug A: yes” and “side effects: yes”, is the most suitable. Hence, in a step 52, the assumption condition in the association rule is set in the precondition input unit 300, and the conclusion condition in the association rule is set in the condition input unit 100.

As described above, even if it is not known that there is a relation between the “side effects of drug A” and “family history of diabetes mellitus”, a result suitable for analytical purposes can be immediately displayed using the association rule. This is therefore effective even for medical data which varies from day-to-day and time to time, such as in the case of epidemic or transient diseases having an unclear focus, and a precise analysis can be performed.

Also, in the second embodiment, 2ⁿ groups of conditions may be taken by selecting an association rule together with conditional input. Specifically, if the patient is a male, “sex: male” is additionally input to the precondition input unit 300 in the step 52, and when the search button 302 is clicked, the ratio of 2ⁿ groups of “drug A: yes” and “side effects: yes” in “ischemic heart disease: yes” and “family history of diabetes mellitus: yes” and “sex: male” is calculated as 2ⁿ groups of conditions. In this way, a relation between the drug A and a side effect suited to the patient can be examined.

(Embodiment 3)

According to the third embodiment of the present invention, a method is shown where an association rule is selected and the ratio of 2ⁿ groups is calculated directly in the step 51 without going through the step 52 in the screen display of FIG. 5.

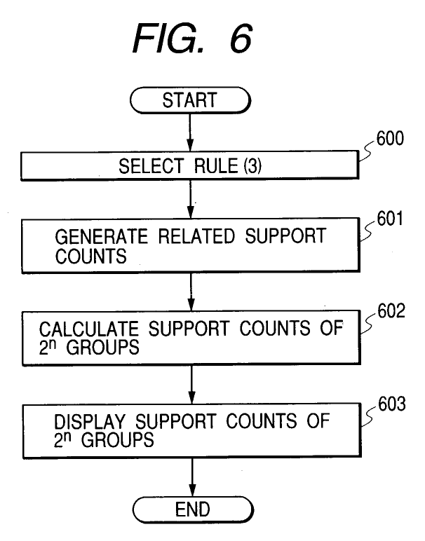

FIG. 6 is a flowchart showing the procedure of medical data analysis in the third embodiment of the present invention.

First, in a step 600, in the association rule selection unit 400, the rule “ischemic heart disease: yes”, “family history of diabetes mellitus: yes” “drug A: yes” and “side effects: yes”, is selected.

In a step 601, in the medical data analysis unit 110, a related support count stored in the data mining result storage unit 420 is generated for the above association rule.

Here, the related support count means the support count including elements which are identical to the selected rule. For example, for the rule A B, C, the support count for A, B, C, A B, A C, B C is shown. In the data mining unit 410, when the rule is deduced, the above related support count is simultaneously calculated, and stored in the data mining result storage unit 420.

In a step 602, in the medical data analysis unit 110, the support count for 2ⁿ groups is calculated from the difference between the support count for the selected rule and the related support count.

For example, for “ischemic heart disease: yes”, “family history of diabetes mellitus: yes” “drug A: yes” “side effects: yes”, 20%, the related support counts are “ischemic heart disease: yes”, “family history of diabetes mellitus: yes” “drug A: yes”, 40%, and “ischemic heart disease: yes”, “family history of diabetes mellitus: yes” “side effects: yes”, 30%.

The support count for the remaining 2ⁿ groups are respectively “ischemic heart disease: yes”, “family history of diabetes mellitus: yes” “drug A: yes”, “except side effects: yes (shows the case for no side effects)”, 40%−20%=20%, “ischemic heart disease: yes”, “family history of diabetes mellitus: yes” “except drug A: yes”, “side effects: yes”, 30%−20%=10%, “ischemic heart disease: yes”, “family history of diabetes mellitus: yes” “except drug A: yes (shows the case without drug A)”, “except side effects: yes”, 100%−(20%+20%+10%)=50%.

In a step 603, in the medical data analysis unit 110, the support count for 2ⁿ groups calculated in the steps 601 and 602 are displayed on the output unit 101.

As described above, in the third embodiment, all the support counts can be calculated from data mining results alone regardless of the data in the medical data storage unit 120 of the database (i.e., without database retrieval), so the computation can be performed rapidly even when there are a large number of conditions.

(Embodiment 4)

In the fourth embodiment of the present invention, 2ⁿ grouping is performed with new conditions as preconditions on the 2ⁿ groups of data.

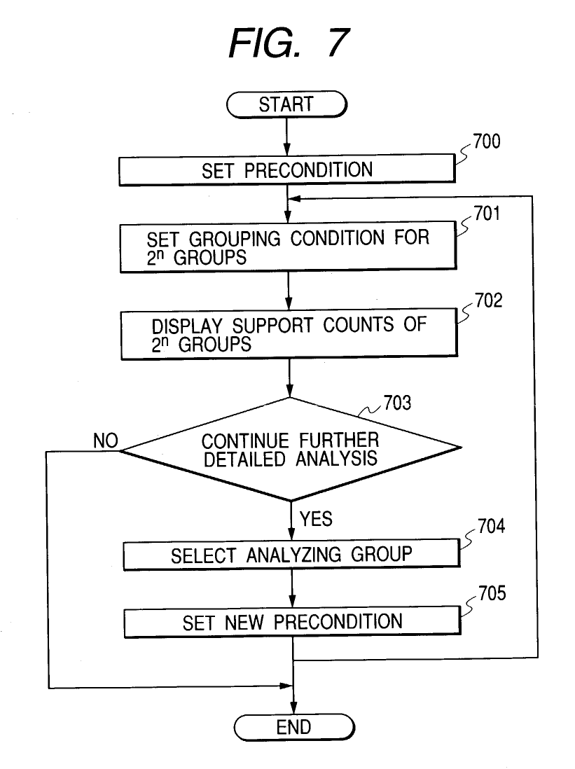

FIG. 7 shows the processing according to the fourth embodiment of the present invention, and is a diagram describing the procedure followed on the screen display referring to the screen embodiment of FIG. 3.

First, in a step 700, in the precondition input unit 300, the precondition “ischemic heart disease: yes” is set. Next, in a step 701, in the condition input unit 100, as the grouping condition for 2ⁿ groups, “drug A: yes”, “side effects: yes” is set. When the search button 302 is clicked, in a step 702, of “ischemic heart disease: yes”, the ratios of “drug A: yes” and “side effects: yes”, “drug A: yes” and “except side effects: yes”, “except drug A: yes” and “side effects: yes”, and “except drug A: yes” and “except side effects: yes”, are displayed as results on the output unit 101.

Next, in a step 703, it is determined whether to continue further detailed analysis. For example, assume that according to the above result, it is known that drug A has serious side effects, and it is desired to know what transpires when another drug B from a group of drugs other than drug A without side effects is administered. For this, in a step 704, on the output unit 101, the group to be analyzed “except drug A, no side effects” is selected. In a step 705, the group to be analyzed is used as a precondition in the precondition input unit 300, i.e., “ischemic heart disease: yes” and “drug A: no” and “side effects: no”, is set. Returning again to the step 701, in the 2ⁿ group condition input unit 100, a condition “drug B: yes” is set to make another grouping of 2ⁿ. In a step 702, when the search button 302 is clicked, the ratio for the 2ⁿ groups “drug B: yes”, “drug B: no” is displayed for the group “ischemic heart disease: yes”, “drug A: no”, “side effects: no” on the output unit 101.

As described above, instead of separating the medical data into medical data related to individual groups from the beginning, a step is further added to group into 2ⁿ groups for data which is already been grouped into 2ⁿ groups of yes/no combinations, so the doctor can perform an analysis targeted at diagnosis or research directly in an easily understandable form.

(Embodiment 5)

A fifth embodiment where analysis is efficiently performed on retrieved data having continuous values, will now be described. In the fifth embodiment, standard value tables are stored in the medical data storage unit 120 of FIG. 1. The standard value tables store lower limiting values and upper limiting values showing allowable ranges for determining normality or abnormality for data such as retrieved data having continuous values.

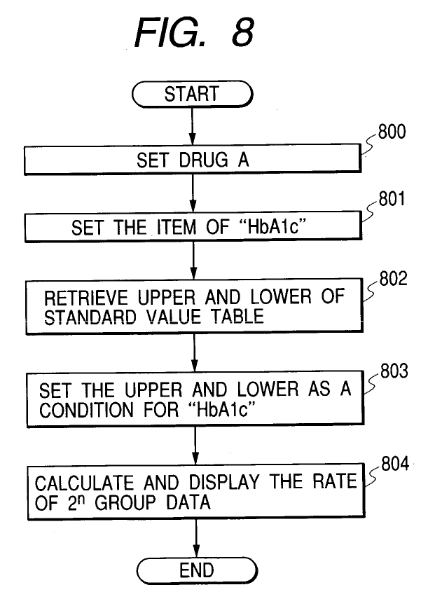

FIG. 8 is a flowchart showing the procedure of the medical data analysis according to the fifth embodiment of the present invention. Here, for example, an embodiment will be shown where the fasting blood sugar level is analyzed to examine the effect of the drug A.

In a step 800, in the condition input unit 100, “drug A: yes” is set, and in a step 801, for “HbA1c”, only the item is set. As “HbA1c” has a standard value, in a step 802, the lower limiting value of 4% and upper limiting value of 6% are looked up from the standard value table, and in a step 803, as the condition for “HbA1c”, 4% is set as the minimum value and 6% is set as the maximum value.

In a step 804, in the medical data analysis unit 110, the ratios of the four groups “HbA1c4%-6%” and “drug A: yes”, “HbA1c4%-6%” and “drug A: no”, “except HbA1c4%-6%” and “drug A: yes”, “except HbA1c4%-6%” and “drug A: no”, are calculated and displayed.

As described above, by automatically setting the normal range as a condition, normal groups and abnormal groups can be immediately compared, and an efficient analysis of data having continuous values can be performed during the diagnosis.

In the aforesaid embodiments, the case n=2 for 2ⁿ groups of data was taken as an embodiment to simplify the description, but will be understood that the present invention may be applied to the case where n is a positive integer and n≧2.

(Embodiment 6)

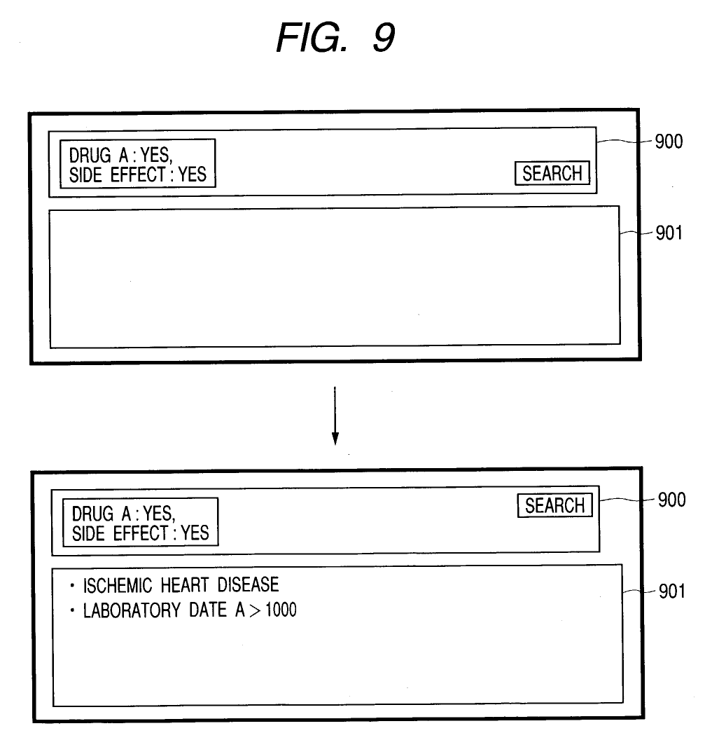

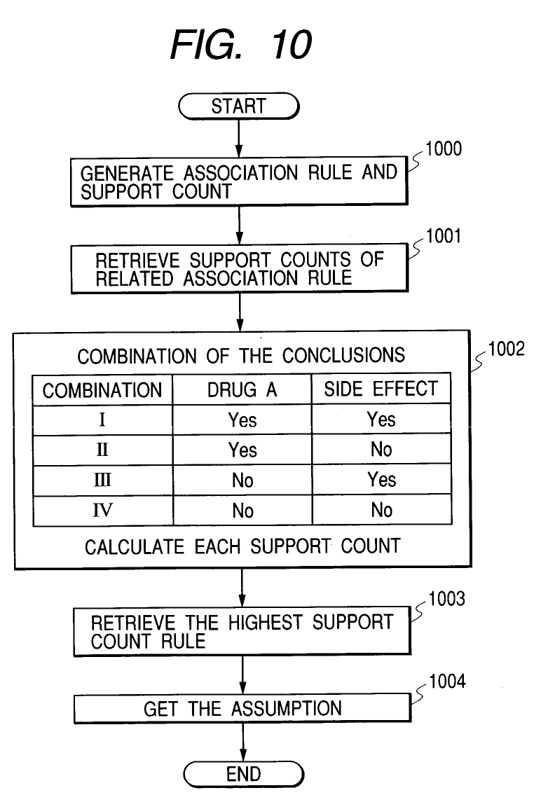

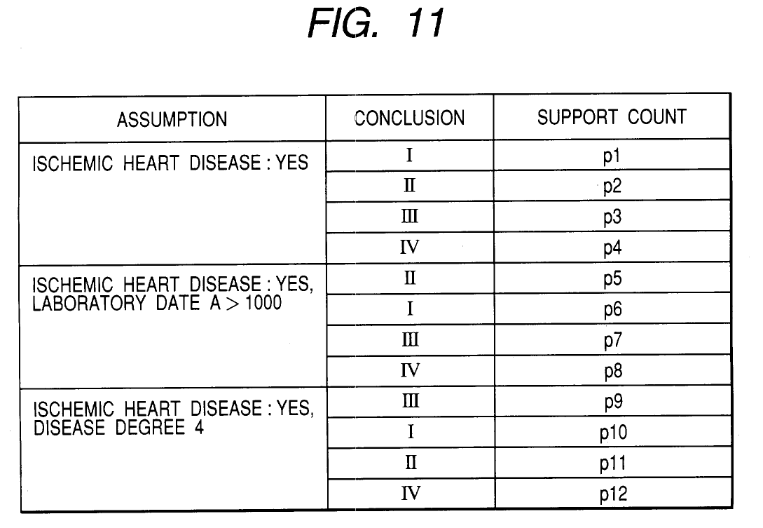

A sixth embodiment where correlation data is generated will now be described. FIG. 9 is a diagram showing a screen display in the sixth embodiment of the present invention, FIG. 10 is a flowchart showing the generation of medical data having the highest correlations in the sixth embodiment of the present invention, and FIG. 11 is a diagram describing the concept of generating correlation data in the sixth embodiment of the present invention.

Here, it will be assumed that when the doctor prescribes drug A to the patient, he desires to check the treatment to be administered in advance. As shown in FIG. 9, “drug A: yes”, “side effects: yes” is first set from a diagnostic data input unit 900. The medical data having the highest correlations is then generated according to the flowchart of FIG. 10, and the generated data, which herein is “ischemic heart disease: yes”, “retrieved value A>1000” is displayed on a correlation medical data output unit 901.

Here, the flowchart of the procedure shown FIG. 10 will be described referring to FIG. 11.

First, in a step 1000 of FIG. 10, data mining is performed on the data in the medical data storage unit 120 of the database, the association rules and support counts described above are generated, and the data mining results are stored in the data mining results storage unit 420 of the database.

In a step 1001, the support counts of association rules (defined in Embodiment 3) are looked up from the data in the data mining results storage unit 420 for association rules having the items “drug A” and “side effects” in the conclusion.

In a step 1002, the rule frequency is calculated for combinations of conclusions from the above association rules and support counts. In the step 1002, combination (I) is “drug A: yes” and “side effects: yes”, combination (II) is “drug A: yes” and “side effects: no”, combination (III) is “drug A: no” and “side effects: yes”, and combination (IV) is “drug A: no” and “side effects: no”.

For example, as shown in FIG. 11, if the support counts p1, p5, p9 are already stored as results, the other support counts p2, p3, p4; p6, p7, p8; p10, p11, p12 are obtained by computation from the support counts of the association rules.

In a step 1003, the highest count is looked up from the obtained support counts. In this case, if the support count p6 has the highest value, in a step 1004, the precondition of the corresponding rule, i.e., “ischemic heart disease: yes”, “laboratory data A is 1000 or higher” is acquired, and displayed on the correlation medical data output unit 901 shown in FIG. 9.

Here, for example, if the doctor has not performed the test A on a patient with ischemic heart disease, it is determined that the test A should be performed. If the laboratory data obtained is 1000 or higher, the doctor can change to a drug other than the drug A for that patient. As described above, navigation to the next medical procedure can be performed by using the support count of the association rule, and this supports the doctor's diagnosis.

In the database 12 of the medical data analytic system of the present invention, medical data centrally managed by a medical institution such as a hospital, clinic or health care center, or by a data center, may be used as the medical data stored in the medical data storage unit 120, or this medical data can be comprehensively analyzed, and data which displays data mining results comprising the generated association rules and support counts may be used.

The program which executes the medical data analysis method of the present invention may be universally applied to a system based on medical data which is centrally managed by a medical institution or data center, and may be added as a new function to prior art systems.

As described by the above embodiments, using the medical data analytic system of the present invention, a large volume of medical data can be efficiently analyzed, the relations between plural analysis items may be displayed in an easily understandable form, and an analysis can be performed even for items for which the focus of the analysis is unknown.

The medical data analytic system and medical data analysis method describing the above embodiments are mainly intended to support diagnosis, but they may also be targeted at supporting research in medical institutions such as hospitals, clinics and health care centers.

As described above, the medical data analytic system of the present invention can efficiently generate relations between data forming evidence from a large volume of medical data, provide useful data for diagnosis, and support a doctor's diagnosis.

What is claimed is:

1. A medical data analytic system comprising a database having a medical data storage unit which stores medical data for analysis, a search condition input unit for inputting n search conditions (where n is a positive integer, and n≧2) relevant to diagnosis, a calculating device comprising a medical data analysis unit which generates 2ⁿ groups corresponding to all of the combinations when said each n search condition is satisfied and when it is not satisfied from medical data for analysis in said medical data storage unit, and calculates a ratio of said generated data relative to all medical data for analysis relevant to said n search conditions, and an input/output device comprising an output unit which outputs the ratio obtained by said calculating device, and said search condition input unit.

2. The medical data analytic system according to claim 1, wherein said calculating device comprises a data mining unit which generates association rules showing data correlations and a support count from said medical data for analysis, said input/output device comprises an association rule selection unit for selecting desired association rules from said association rules, and said medical data analysis unit calculates said ratio according to the association rules selected by said association rule selection unit.

3. The medical data analytic system according to claim 2, wherein said database comprises a data mining result storage unit which stores the association rules and the support count generated by said data mining unit, and said medical data analysis unit calculates said ratio from the support count stored in said data mining result storage unit.

4. The medical data analytic system according to claim 1, wherein said medical data storage unit comprises diagnostic information including laboratory results for diagnosis and a standard value table which stores upper values and lower values showing permitted ranges for said diagnostic information having continuous values, and sets said upper values and lower values as search conditions for said diagnostic information in said search condition input unit.

5. The medical data analytic system according to claim 1, wherein said input/output device displays said ratio obtained by said calculating device.

6. A medical data analysis method, comprising a step for inputting diagnostic preconditions, a step for inputting n search conditions (where n is a positive integer, and n≧2) relevant to diagnosis into input/output means, and a step for generating 2ⁿ groups corresponding to all of the combinations when said each n search condition is satisfied and when it is not satisfied from medical data for analysis prestored in a memory means, and calculating a ratio of said generated data relative to data satisfying said preconditions.

7. The medical data analysis method according to claim 6, including a step for selecting said combinations, and setting new preconditions based on conditions relevant to said selected combinations.

8. The medical data analysis method according to claim 6, comprising a step for displaying said ratio.

9. A medical data analysis method, wherein desired medical data is input, and medical data in medical data for analysis having the highest correlation to said medical data is displayed, comprising:
a step for calculating association rules showing data correlations and a support count from said medical data for analysis;
a step for retrieving said association rules having input medical data items in a conclusion;
a step for calculating the support count relative to combinations of said conclusions from the retrieved association rules; and
a step for displaying assumptions related to combinations of conclusions having the highest support count from the support counts related to combinations of conclusions matching said medical data.
